(19) United States
(12) Patent Application Publication
(10) Pub. No.: US 2015/0026322 A1
(43) Pub. Date: Jan. 22, 2015

(54) CONFIGURING A NETWORK DEVICE

(71) Applicant: Hangzhou H3C Technologies Co., Ltd., Hangzhou, Zhejiang (CN)

(72) Inventors: Lihui Sun, Beijing (CN); Longfei Li, Beijing (CN); Jianxin Li, Beijing (CN); Qi Yang, Beijing (CN)

(21) Appl. No.: 14/373,576

(22) PCT Filed: Mar. 4, 2013
(86) PCT No.: PCT/CN2013/072110

§ 371 Date: Jul. 21, 2014

(30) Foreign Application Priority Data
Mar. 26, 2012 (CN) 201210082991.3

(51) Int. Cl. H04L 12/24

(52) U.S. Cl. CPC H04L 41/0806
USPC 709/222

(57) ABSTRACT

According to an example, a managing server may establish a relation that associates a downlink interface of a gateway device with information of configuration content, receive a request for configuration content from a network device, identify a downlink interface of a gateway device that is directly connected with the network device, and send configuration content corresponding to the downlink interface of the gateway device to the network device based on the relation that associates the downlink interface of the gateway device with the configuration content so as to implement configurations of the network device.

### BACKGROUND

Network devices are typically configured through commands when connected to a network so as to run properly in the network. There are typically a large number of network devices in data centers and in branches of a Wide Area Network. As such, the configuring of all of the network devices via commands every time the network devices are connected to the network often results in relatively large workloads and complex management requirements.

### BRIEF DESCRIPTION OF THE DRAWINGS

Features of the present disclosure are illustrated by way of example and not limited in the following figure(s), in which like numerals indicate like elements, in which:

FIG. 1 is a flowchart illustrating a method for configuring a network device in accordance with an example of the present disclosure.

FIG. 2 is a flowchart illustrating a method for configuring a network device in accordance with an example of the present disclosure.

FIG. 3 is a schematic diagram illustrating a network structure in accordance with an example of the present disclosure.

FIG. 4 is a schematic diagram illustrating a structure of a managing server in accordance with an example of the present disclosure.

FIG. 5 is a schematic diagram illustrating a structure of an apparatus for configuring a network device in accordance with an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

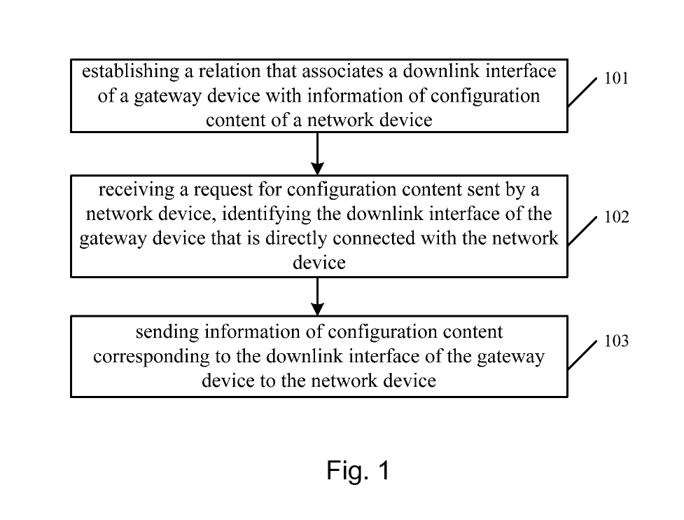

FIG. 1 is a flowchart illustrating a method for configuring a network device in accordance with an example of the present disclosure. As shown in FIG. 1, the method may include the following procedures.

In block 101, a relation that associates a downlink interface of a gateway device with information of configuration content of a network device may be established.

In block 102, a request for configuration content may be received from a network device. In addition, a downlink interface that is an interface of the gateway device and is directly connected with the network device may be identified.

In block 103, information of configuration content corresponding to the downlink interface of the gateway device may be sent to the network device.

The above process may be implemented by a device in the network, e.g., a managing server or another device that is able to communicate with the gateway device and the network device. The following description takes as an example, a managing server implementing the above process. The information of configuration content may be the content of the configuration, e.g., a whole configuration file or part of a configuration file of the network device. The information of configuration content may also be a manner of obtaining the configuration content, e.g., a parameter for accessing a file server that stores the configuration content and the name of a configuration file.

The method of FIG. 1 may implement automatic configuration of a network device connected to the network via a downlink interface of the gateway device based on the downlink interface. The above method may be implemented in a network that includes a gateway device, a dynamic host configuration protocol (DHCP) server, a managing server, and a file server.

In the above block 102, the downlink interface of the gateway device that is directly connected with the network device may be obtained from an address resolution protocol (ARP) table of the gateway device, or may be identified by using information reported by the gateway device about the network device directly connected to the downlink interface. The former manner may not require modification to conventional interaction procedures between the devices, and therefore may require less modification to the devices. The latter manner may require a gateway device to report information, e.g., an IP address or the like, of a network device connected with a downlink interface of the gateway device when the downlink interface becomes UP. An example adopts a downlink interface configuration state list to record the configuration state of each downlink interface of each gateway device to further simplify the process of a managing server searching for the downlink interface of a gateway device connected with a specified network device. The process of the example may be as follows.

A managing server may establish a relation that associates a downlink interface of a gateway device with configuration content of a network device. When a network device is physically connected and turned on and is connected to the network via a gateway device, the managing server may receive an alert from the gateway device indicating a downlink interface of the gateway device is UP, and may generate a network device configuration state list based on the alert. The network device configuration state list may include an identification of the gateway device, an identification of the downlink interface, and a configuration state of the network device directly connected to the downlink interface. The configuration state may be initiated to be a value indicating “not processed”. The managing server may receive from the network device a request for obtaining configuration content. The managing server may identify the downlink interface of the gateway device that is directly connected with the network device that sent the request by using an ARP table of the gateway device whose downlink interface corresponds to a configuration state indicating “not processed” in the network device configuration state list. The managing server may send configuration content corresponding to the downlink interface to the network device and the network device may implement configurations according to the configuration content.

The managing server may modify the configuration state corresponding to the downlink interface in the network device configuration state list into a value indicating “configurations done” after sending the configuration content to the network device.

By recording in the network device configuration state list a downlink interface of a gateway device for which an alert of the interface being UP has been received but configurations have not been done, the above method does not have to search in ARP tables of all of the gateway devices but may only search in the ARP tables of gateway devices that have un-configured downlink interfaces after a request for configuration content is received from a network device. As such, the gateway device and the downlink interface connected with the network device that sent the request may be quickly identified.

In an example, after receiving an alert sent by a gateway device that a downlink interface is Down, e.g., when a failure has occurred in a network device, the managing server may determine the network device configuration state list corresponding to the downlink interface, and may delete the network device configuration state list.

According to the example, when a failure occurs in a network device and a new network device is turned on and connected to the network via the downlink interface via which the failed network device was connected to the network, the managing server may receive an alert sent by the gateway device that the downlink interface is UP. The managing server may also generate a network device configuration state list including an identification of the gateway device, an identification of the downlink interface, and a configuration state of the network device directly connected to the downlink interface. The managing server may further receive a request for configuration content sent by the new network device and may obtain the downlink interface of the gateway device that is directly connected with the new network device sending the request from an ARP table of the gateway device whose downlink interface corresponds to a configuration state of “not processed” in the network device configuration state list. The managing server may send configuration content corresponding to the downlink interface to the new network device, and the new network device may implement configurations by using the configuration content.

According to another example, after receiving an alert sent by a gateway device indicating that a downlink interface of the gateway device is Down, the managing server may first obtain the network device configuration state list corresponding to the downlink interface of the gateway device, end the process in response to a determination that the configuration state in the network device configuration state list is “not processed”, or set the configuration state in the network device configuration state list to be a first pre-set value indicating the downlink interface has become Down from UP.

After receiving the alert sent by the gateway device indicating that the downlink interface is UP, the managing sever may search for the network device configuration state list corresponding to the downlink interface of the gateway device. If the network device configuration state list is found, the configuration state in the network device configuration state list is set to be a second pre-set value indicating that the downlink interface has become UP again. If the network device configuration state list is not found, the managing server may generate a network device configuration state list including the identification of the gateway device, the identification of the downlink interface, and a configuration state of the network device directly connected to the downlink interface based on the alert. After receiving a configuration request from a network device, the managing server may first identify gateway devices corresponding to downlink interface configuration state lists whose configuration state indicates “not processed” or is the second pre-set value. The managing server may then search for the downlink interface corresponding to the network device in ARP tables of the gateway devices, perform the above processing, and modify the configuration state in the downlink interface configuration state list corresponding to the downlink interface into “configurations done” if the configuration state is “not processed.” The managing server may also send a response to the network device without sending the configuration content if the configuration state is the second pre-set value that indicates that the downlink interface has been configured previously. When receiving the response instead of the configuration content, the network device may determine that the current configurations of the network device are the required configurations.

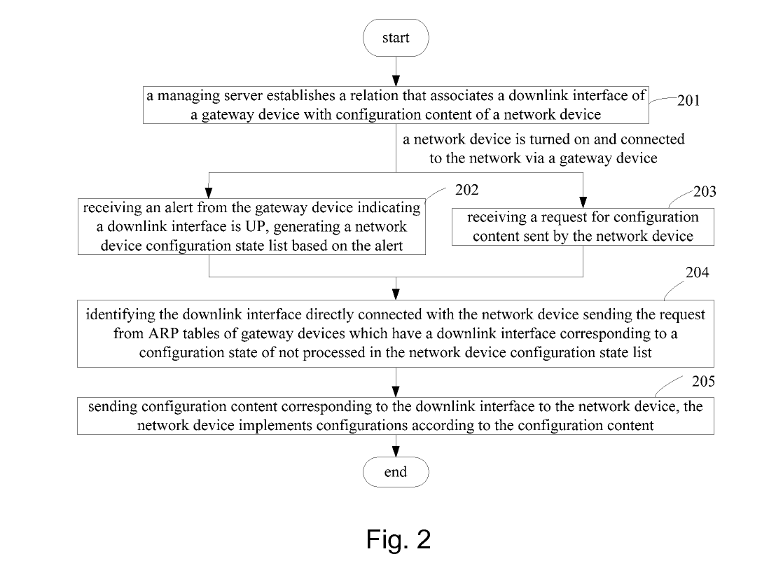

FIG. 2 is a flowchart illustrating a method for automatically configuring a network device in accordance with an example of the present disclosure. As shown in FIG. 2, the method may include the following procedures.

In block 201, a managing server may establish a relation which associates a downlink interface of a gateway device with configuration content of a network device.

The configuration content of the network device may be stored in the managing server or in a file server, and the configuration content may be a whole configuration file or part of a configuration file of the network device.

After the procedure in block 201, procedures in blocks 202 and 203 may be performed after a network device is physically connected and turned on and is connected to the network via the gateway device. In an example, the procedure in block 203 may be performed after the procedure in block 202.

In block 202, the managing server may receive an alert from a gateway device indicating that a downlink interface of the gateway device is UP and may generate a network device configuration state list based on the alert, in which the network device configuration state list may include an identification of the gateway device. The managing server may also receive an identification of the downlink interface and a configuration state of the network device directly connected to the downlink interface.

After the network device is physically connected and turned on and is connected to the network via the gateway device, the downlink interface via which the network device is connected to the network becomes UP, an alert indicating the downlink interface is UP may be sent to a managing server in the network. The managing server may generate a network device configuration state list based on the alert. The network device configuration state list may include an identification of the gateway device, an identification of the downlink interface, and a configuration state of the network device directly connected with the downlink interface. The identification of the gateway device may be a gateway device ID. The identification of the downlink interface may be the ID of the downlink interface which becomes UP. The configuration state of the network device directly connected to the downlink interface may be initiated to be a value indicating “not processed”. The configuration state may be a value indicating “not processed” or a value indicating “configurations done”, to indicate whether the network device has sent a request to obtain configuration content.

The network device configuration state list in the managing server may be stored in any form, e.g., a list including configuration states of all gateway devices, multiple lists, each of which is established for one gateway device, or multiple lists, each of which is established for one downlink interface of one gateway device. Details of the implementation may be designed according to individual needs, and are thus not limited herein.

In this procedure, the managing server may receive the alert indicating that the downlink interface of the gateway is UP via a Simple Network Management Protocol (SNMP) TRAP packet. Other examples may adopt other packets for receiving the alert without departing from a scope of the present disclosure.

In block 203, the managing server may receive a request from a network device for obtaining configuration content.

When the network device is turned on and connected to the network via a gateway device, the network device may send a request for an IP address to a DHCP server before the above procedure is implemented. The network device may receive an IP address assigned by the DHCP server and a parameter stored in the DHCP server for accessing the managing server. The network device may send the request for configuration content to the managing server by using the parameter for accessing the managing server. Thus, the network device is able to send the request to the managing server correctly. The parameter for accessing the managing server may include the IP address of the managing server, a user name, a password, and so on.

In this procedure, the managing server may receive the request for configuration content sent by the network device via a Technical Report 069 (TR069) protocol packet. Other examples may adopt other packets for receiving the request from the network device without departing from a scope of the present disclosure.

According to an example, after the procedure in block 203, procedures in block 204 may be performed.

In block 204, a downlink interface of a gateway device, which is directly connected with the network device sending the request, may be obtained from ARP tables of gateway devices whose downlink interfaces correspond to a configuration state of “not processed” in the network device configuration state list.

In block 204, obtaining the downlink interface directly connected with the network device sending the request from ARP tables of gateway devices whose downlink interface corresponds to a configuration state of “not processed” in a network device configuration state list may include the following process.

In an example, the managing server may obtain information of gateway devices that have a downlink interface corresponding to a configuration state of “not processed” in the network device configuration state list, may obtain a downlink interface corresponding to the IP address of the network device sending the request from an ARP table, and may identify the downlink interface corresponding to the network device sending the request based on the information of the gateway devices obtained and the downlink interface.

In another example, the managing server may determine the gateway device corresponding to the network device by using the network device configuration state list and the IP address of the network device sending the request and may obtain the downlink interface corresponding to the network device from the ARP table of the gateway device based on the IP address of the network device.

In yet another example, after receiving the request from the network device, the managing server may obtain the IP address of the network device and may obtain network device configuration state lists in which the configuration state is “not processed” and for which an alert has been received. Then, the managing server may check the ARP table of each gateway device that has sent an alert until the IP address of the network device is found. The gateway device whose ARP table includes the IP address of the network device is the gateway device directly connected with the network device and the data entry including the IP address in the ARP table is the entry for the downlink interface directly connected with the network device. Therefore, the identification of the gateway device and the identification of the downlink interface may be obtained.

At the end of this procedure, the configuration state corresponding to the downlink interface, which is UP, is set to be “configurations done”.

If the gateway device and the downlink interface that are directly connected with the network device are not found in the current network device configuration state lists, multiple attempts may be performed. When the gateway device and the downlink interface are not found after multiple attempts, the process is regarded as having failed and is ended. The multiple attempts may refer to multiple attempts at different times to obtain the gateway device and the downlink interface to avoid failure that resulted in that the obtaining process may be performed before data in the lists is refreshed, i.e., the obtaining process may be performed again after a period of time.

In block 205, configuration content corresponding to the downlink interface may be provided for the network device, and the network device may implement configurations according to the configuration content.

The managing server may send the configuration content corresponding to the downlink interface to the network device. Or, the managing server may send information of the configuration content corresponding to the downlink interface, e.g., a manner of obtaining the configuration content or the like, to the network device, which may then obtain the configuration content by using the information. For example, the network device may obtain the configuration content from a file server by using the manner of obtaining the configuration content.

The manner of obtaining the configuration content may be a parameter for accessing the file server storing the configuration content and the name of a configuration file. The managing server may send the manner for obtaining the configuration content corresponding to the downlink interface to the network device via a TR069 protocol packet. Other examples may adopt other packets for sending the manner of obtaining the configuration content to the network device.

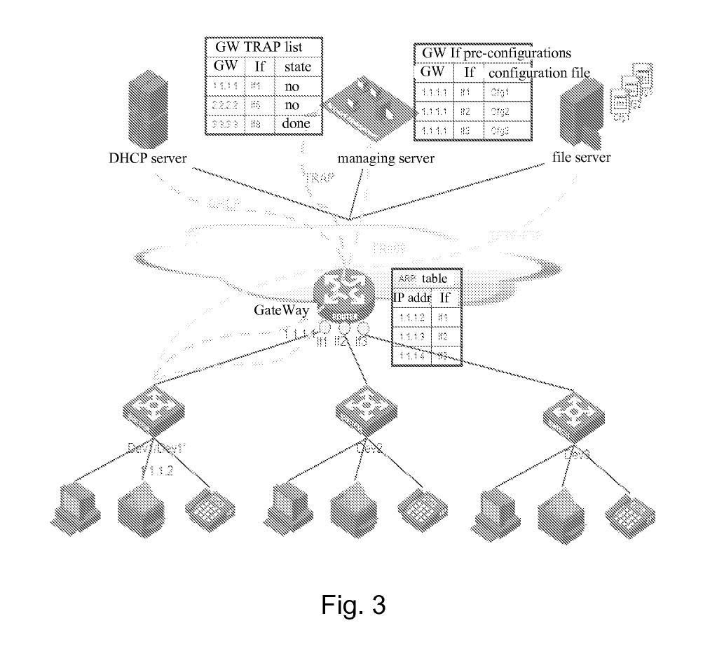

The method depicted in FIG. 2 is described in further detail in the following by taking the network as shown in FIG. 3 as an example. As shown in FIG. 3, a managing server, a DHCP server, and a file server (if configuration files are stored in the managing server, the file server may be omitted) are respectively connected with a gateway device, and the gateway device is connected with three network devices Dev1, Dev2 and Dev3 via downlink interfaces If1, If2 and If3 respectively.

Firstly, the following relations may be established in the managing server for the downlink interfaces If1, If2, If3 of the gateway device and configuration files: a first relation that associates If1 of gateway device 1.1.1.1 with configuration file Cfg1, a second relation that associates If2 of gateway device 1.1.1.1 with configuration file Cfg2, and a third relation that associates If3 of gateway device 1.1.1.1 with configuration file Cfg3.

When network device Dev1 is turned on and connected to the network via the gateway device, interface If1 of the gateway device is UP, and the gateway device may send an alert to the managing server. The managing server may generate a network device configuration state list for the downlink interface, which is UP, and the configuration state of the network device directly connected with the downlink interface in the list is set as “not processed”. Dev1 may acquire an IP address from the DHCP server, and may obtain a parameter for accessing the managing server from the DHCP server. Then, Dev1 may send a request for configuration content to the managing server.

After receiving the request from Dev1, the managing server may obtain the IP address 1.1.1.2 of Dev1, check stored network device configuration state lists and may determine that gateway devices 1.1.1.1 and 2.2.2.2 have downlink interfaces directly connected with network devices whose configuration state is “not processed”. The managing server may communicate with the two gateway devices respectively to obtain ARP tables of the two gateway devices and may then determine that the IP address of Dev1 is included in the ARP table of gateway device 1.1.1.1 and corresponds to downlink interface If1. The managing server may therefore determine that Dev1 is directly connected with If1 of gateway device 1.1.1.1. The managing server may search in the relations between downlink interfaces of gateway devices and configuration files and may determine that configuration content corresponding to Dev1 is stored in Cfg1. The managing server may then send a response to Dev1 indicating that the manner of obtaining the configuration content is file Cfg1 stored in the file server, and may modify the configuration state of If1 of gateway device 1.1.1.1 in the network device configuration state list to “configurations done”. Dev1 may obtain Cfg1 from the file server according to the manner of obtaining configuration content provided by the managing server and may implement configurations of the Dev1 by executing Cfg1.

Further, when network device Dev1 malfunctions, an administrator may replace Dev1 with a network device Dev1′, which has not been configured. When Dev1′ is turned on and connected to the network via If1, detailed processing is the same as that of Dev1, and will not be described further.

After obtaining Cfg1, Dev1′ implements configurations of Dev1′, and replaces Dev1 in the network.

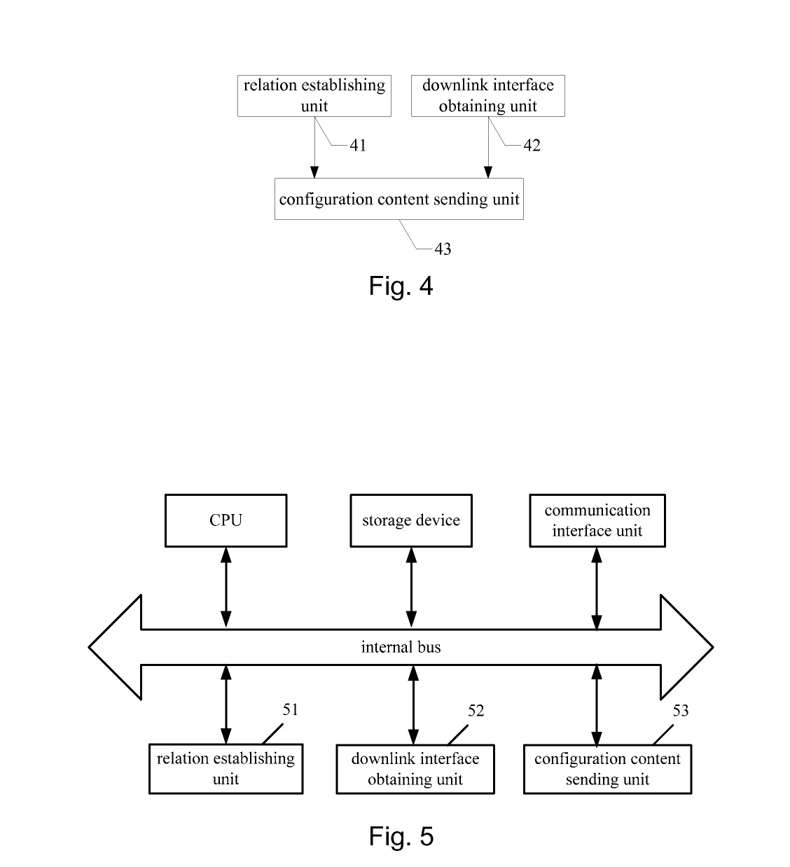

FIG. 4 is a schematic diagram illustrating a structure of a managing server in accordance with an example of the present disclosure. The managing server may be implemented in a network that includes a gateway device, a DHCP server, and a file server. As shown in FIG. 4, the managing server may include a relation establishing unit 41, a downlink interface obtaining unit 42, and a configuration content sending unit 43.

The relation establishing unit 41 may establish a relation that associates a downlink interface of a gateway device with information of configuration content of a network device. The configuration content of the network device may be a whole configuration file or part of a configuration file of the network device.

The downlink interface obtaining unit 42 may receive a request for configuration content sent by a network device and may identify a downlink interface that is an interface of a gateway device and is directly connected with the network device. For example, the downlink interface obtaining unit 42 may receive an alert from a gateway device indicating a downlink interface of the gateway device is UP, generate a network device configuration state list including an identification of the gateway device, an identification of the downlink interface, and a configuration state of a network device directly connected with the downlink interface. The downlink interface obtaining unit 42 may also receive a request for configuration content from a network device, obtain a downlink interface directly connected with the network device sending the request from an ARP table of a gateway device having a downlink interface that corresponds to a configuration state of “not processed” in a network device configuration state list.

In an example, the downlink interface obtaining unit 42 may receive the alert from the gateway device indicating the downlink interface is UP via a TRAP packet, and may receive the request for configuration content from the network device via a TR069 protocol packet.

The configuration content sending unit 43 may send configuration content corresponding to the downlink interface obtained by the downlink interface obtaining unit 42 in the relation establishing unit 41 to the network device. For example, the configuration content sending unit 43 may send the configuration content corresponding to the downlink interface obtained by the downlink interface obtaining unit 42 in the relation establishing unit 41 to the network device to enable the network device to implement configurations according to the configuration content.

In an example, the configuration content sending unit 43 may send configuration content corresponding to the downlink interface obtained by the downlink interface obtaining unit 42 in the relation establishing unit 41 to the network device. Alternatively, the configuration content sending unit 43 may send a manner of obtaining the configuration content corresponding to the downlink interface in the relation establishing unit 41 to the network device to enable the network device to obtain the configuration content from a file server according to the manner of obtaining the configuration content. The manner of obtaining the configuration content may include a parameter for accessing the file server storing the configuration content and the name of a configuration file.

In an example, the configuration content sending unit 43 may send the manner of obtaining the configuration content corresponding to the downlink interface to the network device via a TR069 protocol packet.

The managing server of FIG. 4 may be implemented as shown in FIG. 2, and will therefore not be described further herein.

FIG. 5 is a schematic diagram illustrating a structure of a managing server in accordance with an example of the present disclosure. As shown in FIG. 5, the managing server may include a relation establishing unit 51, a downlink interface obtaining unit 52, and a configuration content distributing unit 53.

The relation establishing unit 51 may establish a relation that associates a downlink interface of a gateway device with information of configuration content of a network device.

The downlink interface obtaining unit 52 may receive a request for configuration content from a network device and may obtain a downlink interface of a gateway device that is directly connected with the network device from ARP tables of gateway devices.

The configuration content sending unit 53 may send configuration content corresponding to the downlink port of the gateway device is sent to the network device.

In another example, the relation establishing unit 51, the downlink interface obtaining unit 52, and the configuration content sending unit 53 may respectively have the same functions as the relation establishing unit 41, the downlink interface obtaining unit 42 and the configuration content sending unit 43.

The relation establishing unit 51, the downlink interface obtaining unit 52, and the configuration content sending unit 53 may be logic modules having different functions, and may be implemented by the same physical module or by a plurality of sub modules. It should be understood that the managing server may include additional modules. For example, the managing server may further include a CPU, a memory, a communicating interface unit, an internal bus, etc. Functions of the above modules 51, 52, and 53 may be implemented with assistance of other modules, e.g., the CPU may assist in performing various computations, the memory may assist in storing various states, data and lists such as the configuration file, the network device configuration state list, the ARP table and temporary data, and so on. In the above description, various functions are described as being implemented by the modules 51, 52 and 53 for purposes of brevity. The internal bus provides communication tunnels between the modules, which may be a bus connected with each of the modules or multiple wired or wireless connections between the multiple modules.

It should be understood that in the above processes and structures, all of the procedures and modules may not be necessary and that certain procedures or modules may be omitted without departing from a scope of the present disclosure. The order of the procedures may not be fixed and may thus be adjusted without departing from a scope of the present disclosure. The modules are defined based on function simply for facilitating description. In implementation, a module may be implemented by multiple modules, and functions of multiple modules may be implemented by the same module. The modules may reside in the same device or may be distributed in different devices.

In view of the foregoing, according to the method for configuring a network device and the managing server, the managing server may first establish relations that associate downlink interfaces of gateway devices with configuration content of network devices. When a network device is turned on and is connected to the network via a downlink interface of a gateway device, the managing server may receive a request for configuration content from the network device, may identify the downlink interface of the gateway device that is directly connected with the network device sending the request based on an ARP table and a network device configuration state list including an identification of the gateway device, an identification of the downlink interface generated by the managing server, and may send configuration content corresponding to the identified downlink interface to the network device to enable the network device to implement configurations. The method for configuring a network device may first establish a relation that associates a downlink interface of a gateway device with configuration content of a network device, therefore, when the downlink interface and the gateway device via which the network device is connected to the network are identified, the managing server may send configuration content corresponding to the downlink interface of the gateway device to the network device to enable the network device to implement the configurations. Therefore, the above method may implement automatic configuration of a network device connected to the network based on the downlink port of the gateway device via which the network device is connected with the network.

According to examples of the method disclosed herein, when a failure occurs in a network device and a new network device is connected to the network via the downlink interface of the gateway device via which the failed network device was connected to the network, the managing server may receive a request for configuration content from the new network device, may identify the downlink interface by using the request, and may send the configuration content corresponding to the downlink interface to the new network device to enable the new network device to implement configurations. That is, when a network device fails and a new network device is connected to the network, no extra configurations may be needed because the method for configuring a network device disclosed herein may configure the network device based on the downlink interface of the gateway device.

In various examples, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations.

The methods and apparatuses provided herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD, and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above examples and which may make the system or the apparatus (or CPU or MPU) read and execute the program codes stored in the storage medium. In this example, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize the technical scheme of any of the above examples.

In addition, the program codes implemented from a storage medium may be written in a storage in an extension board inserted in the computer or in a storage in an extension unit connected to the computer. In this example, a CPU in the extension board or the extension unit executes at least part of the operations according to the instructions based on the program codes to realize any of the above examples.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for configuring a network device, said method comprising:
establishing, by a managing server, a relation that associates a downlink interface of a gateway device with information of configuration content of a network device;
receiving a request for configuration content from a network device;
obtaining a downlink interface of a gateway device that is directly connected with the network device; and
sending information of configuration content corresponding to the downlink interface of the gateway device to the network device based on a relation that associates the downlink interface of the network device with the information of the configuration content.

2. The method of claim 1, wherein obtaining the downlink interface of the gateway device that is directly connected with the network device comprises:
obtaining the downlink interface of the gateway device directly connected with the network device from an address resolution protocol (ARP) table of the gateway device; or
identifying the downlink interface of the gateway device that is directly connected with the network device by using information of the network device directly connected with the downlink interface reported by the gateway device.

3. The method of claim 2, wherein obtaining the downlink interface of the gateway device directly connected with the network device from an ARP table of the gateway device comprises:
receiving, by the managing server, an alert from the gateway device indicating that the downlink interface is UP;
generating a network device configuration state list including an identification of the gateway device, an identification of the downlink interface, and a configuration state of the network device directly connected with the downlink interface, wherein the configuration state is initiated to a value indicating that the configuration of the network device is not processed; and
identifying the downlink interface of the gateway device that is directly connected with the network device sending the request from ARP tables of gateway devices that have a downlink interface corresponding to a configuration state of not processed in the network device configuration state list after receiving the request for configuration content from the network device.

4. The method of claim 3, wherein identifying the downlink interface of the gateway device that is directly connected with the network device sending the request from ARP tables of gateway devices that have a downlink interface corresponding to a configuration state of not processed in the network device configuration state list comprises:
identifying, by the managing server, gateway devices that have a downlink interface corresponding to a configuration state of not processed in the network device configuration state list;
obtaining the downlink interface corresponding to an IP address of the network device sending the request from ARP tables of the gateway devices; and
taking the downlink interface identified as the downlink interface corresponding to the network device sending the request.

5. The method of claim 3, wherein the alert indicating the downlink interface is UP is received by the managing server from the gateway device via a TRAP protocol packet.

6. The method of claim 3, wherein the request for configuration content is received by the managing server from the network device via a TR069 protocol packet and wherein the configuration content corresponding to the downlink interface is sent by the managing server to the network device via a TR069 protocol packet.

7. The method of claim 1, wherein sending by the managing server information of the configuration content corresponding to the downlink interface of the gateway device to the network device comprises:
sending, by the managing server, the configuration content corresponding to the downlink port to the network device; or
sending, by the managing server, a manner of obtaining the configuration content corresponding to the downlink interface to the network device that is to obtain the configuration content from a file server by using the manner of obtaining the configuration content.

8. The method of claim 7, wherein the manner of obtaining the configuration content comprises: a parameter for accessing the file server storing the configuration content and a name of a configuration file.

9. An apparatus for configuring a network device, comprising:
a relation establishing unit to establish a relation that associates a downlink interface of a gateway device with information of configuration content of a network device;
a downlink interface obtaining unit to receive a request for configuration content from a network device and to identify a downlink interface of a gateway device that is directly connected with the network device; and
a configuration content sending unit to send information of configuration content corresponding to the downlink interface obtained by the downlink interface obtaining unit in the relation establishing unit to the network device.

10. The apparatus of claim 9, wherein the downlink interface obtaining unit is further to obtain the downlink interface of the gateway device from an address resolution protocol (ARP) table of the gateway device, or identify the downlink interface of the gateway device that is directly connected with the network device by using information of the network device directly connected with the downlink interface reported by the gateway device.

11. The apparatus of claim 9, wherein the downlink interface obtaining unit is further to receive an alert from a gateway device indicating a downlink interface of the gateway device is UP, generate a network device configuration state list that includes an identification of the gateway device, an identification of the downlink interface, and a configuration state of a network device directly connected with the downlink interface, wherein the configuration state is initiated to be a value indicating that the configuration of the network device is not processed, receive a request for configuration content from a network device, obtain the downlink interface of the gateway device that is directly connected with the network device sending the request from ARP tables of gateway devices that have a downlink interface corresponding to a configuration state indicating not processed in the network device configuration state list.

12. The apparatus of claim 11, wherein the downlink interface obtaining unit is to receive the alert indicating that the downlink interface is UP from the gateway device via a TRAP packet.

13. The apparatus of claim 11, wherein the downlink interface obtaining unit is to receive the request for configuration content from the network device via a TR069 protocol packet, and wherein the configuration content sending unit is to send a manner of obtaining the configuration content corresponding to the downlink interface to the network device via a TR069 protocol packet.

14. The apparatus of claim 9, wherein the configuration content sending unit is to:
send the configuration content corresponding to the downlink interface in the relation establishing unit to the network device; or
send a manner of obtaining the configuration content corresponding to the downlink interface in the relation establishing unit to the network device.

15. The apparatus of claim 14, wherein the configuration content sending unit is to send a whole configuration file or part of a configuration file of the network device to the network device as the configuration content or send a parameter for accessing a file server and a name of a configuration file as the manner of obtaining the configuration content corresponding to the downlink interface to the network device.
